(19) United States
(12) Patent Application Publication
(10) Pub. No.: US 2010/0242371 A1
(43) Pub. Date: Sep. 30, 2010

(54) WINDOW SHIELD AND SHIELD MOUNTING BRACKET AND METHOD FOR USE

(76) Inventor: Richard E. Foltz, Mukilteo, WA (US)

Correspondence Address: Karr Tuttle Campbell;ATTN: PRIYA SINHA CLOUTIER, 1201 Third Ave., Ste 2900, Seattle, WA, 98101, US

(21) Appl. No.: 12/729,411

(22) Filed: Mar. 23, 2010

Related U.S. Application Data
(60) Provisional application No. 61/162,928, filed on Mar. 24, 2009.

(51) Int. Cl. E06B 3/30; B65D 25/00; B23P 17/04

(52) U.S. Cl. 49/460; 49/506; 220/737; 29/527.1

(57) ABSTRACT

The purpose of the current invention is to provide a system and method that provides an effective and visually appealing way to board windows and doors.

### CROSS-REFERENCES TO RELATED APPLICATIONS

This application claims priority to provisional application No. 61/162,928, filed on 24 Mar. 2009, and incorporated in its entirety by reference.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND

In October 2008, the United States national economy plummeted and foreclosures mounted around the country. Houses and storefronts are sitting empty for months. To prevent vandalism of these houses and storefronts, windows are being boarded, turning neighborhoods into eyesores. Cities, from coast to coast, are reacting to the boarded windows. For example, Garland, Tex., requires owners of abandoned or distressed properties to post a bond to the City so that it can maintain the property. And, Chicago, Ill., allows owners to use plywood on doors and windows for only six months.

Owners of houses and storefronts also board windows and doors when expecting a storm. Those who live in Hurricane or Tornado Alley may board windows and doors at least once a year. However, for owners who do not plan ahead, tracking down plywood during a storm warning may become a problem, and if weather strikes quicker than anticipated, the job may not be completed in a timely manner.

Some homeowners may live in a home only a portion of the year, traveling or living in another place the remainder of the year. These homeowners may wish to board windows and doors when away. However, boarding doors and windows may actually pose a security risk because would be thieves and vandals have notice that the house is vacant.

Boarding windows and doors can also provide insulation. However, this application may not be utilized because it will make the house or storefront look blighted and prevent sunlight from coming into the building.

Generally, the process of boarding windows and doors is difficult. First, the boarding process does require some knowledge of carpentry. Second, plywood is heavy; it can be difficult for a homeowner or a storefront owner to handle large, unwieldy boards of plywood. Finally, drilling holes into window and door frames can cause moisture to enter unprotected holes and frames, if the holes are not filled or repaired.

The purpose of the current invention is to provide a system and method that provides an effective and visually appealing way to board windows and doors.

### BRIEF DESCRIPTION OF THE SEVERAL VIEWS OF THE DRAWINGS

Other features and advantages of the present invention will become apparent in the following detailed descriptions of the preferred embodiment with reference to the accompanying drawings, of which:

FIG. 1 is a side view of the bracket;

FIG. 2. is a top view of the mount;

FIG. 2a is a front view of the mount;

FIG. 2b is a side view of the mount;

FIG. 3 is a side view of the frame;

FIG. 3a is a back side view of the frame;

FIG. 3b is top view of the frame;

FIG. 4 is a top view of the jamb;

FIG. 4a is a side view of the jamb;

FIG. 4b is a end view of the jamb;

FIG. 5 shows mounts attached to a structure;

FIG. 6 is an exploded view of the mount and frame;

FIG. 7 is an exploded view of the mount, frame and jamb

FIG. 8 is a view of the shield;

FIG. 9 shows the male and female end of a connector;

FIG. 10 shows shields being joined by connectors.

### DETAILED DESCRIPTION OF THE INVENTION

In the description of the invention above, and in the detailed description of the invention, and the claims below, and in the accompanying drawings, reference is made to particular features (including method steps) of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally. The invention described herein is an apparatus, system and method used to board windows and doors.

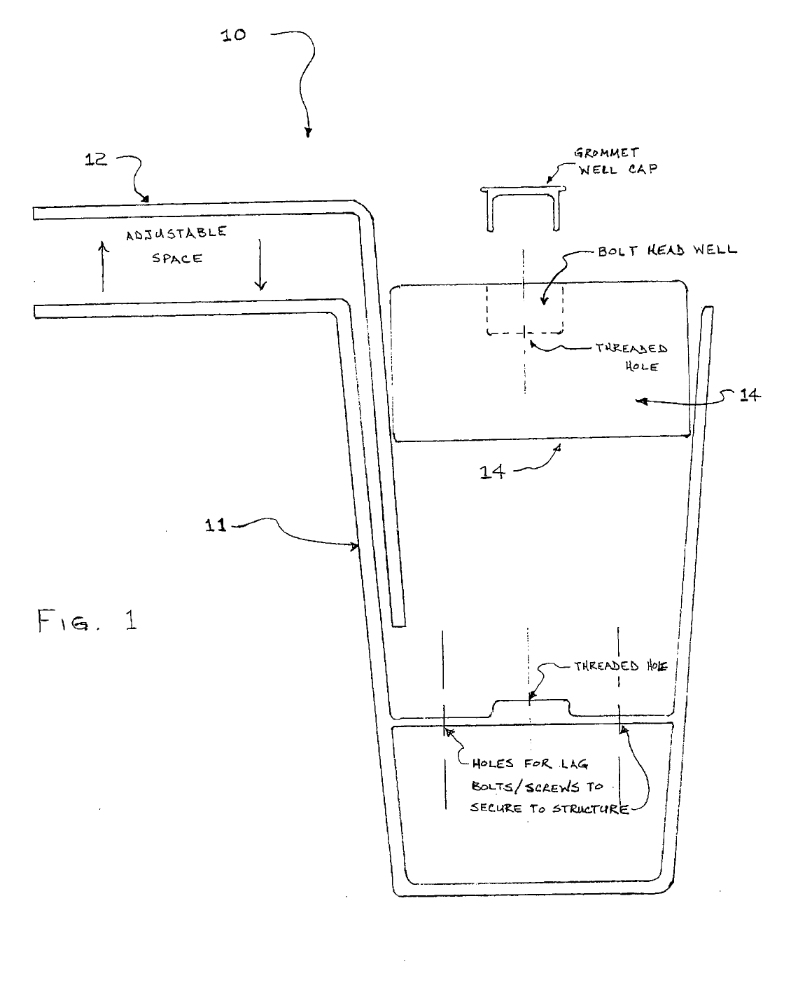

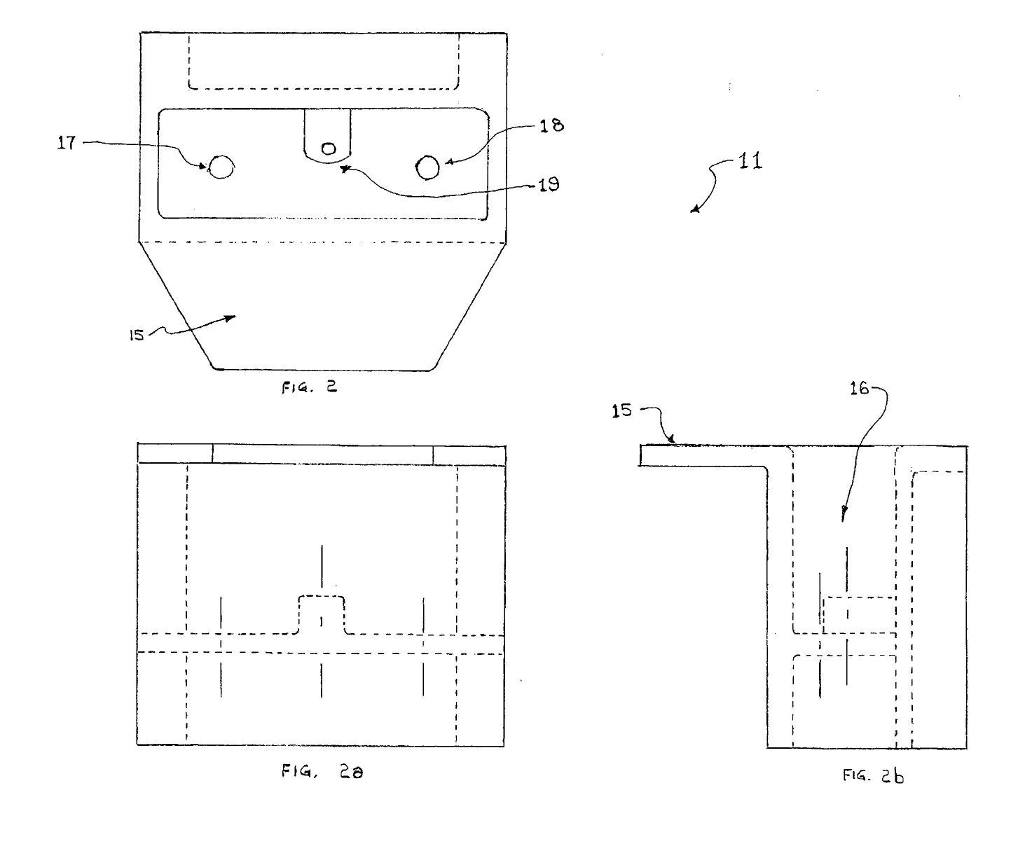

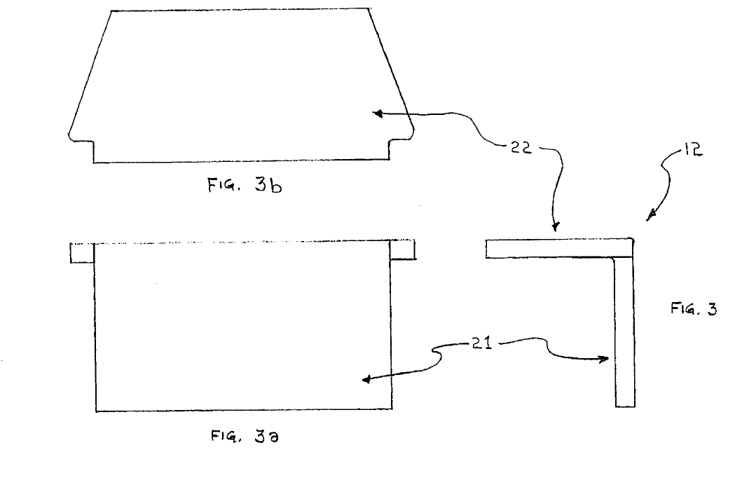

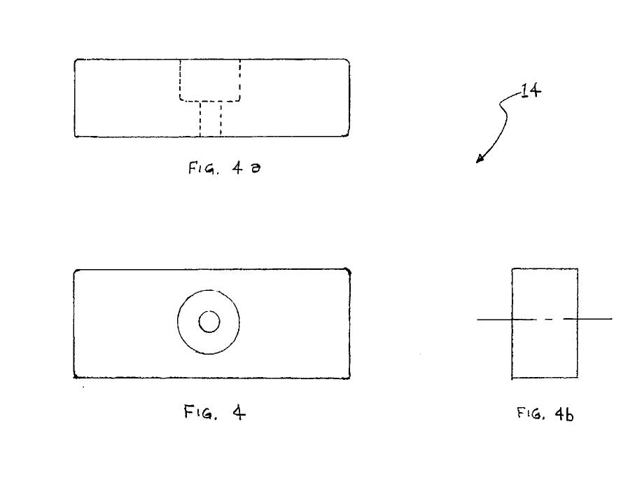

BRACKET. Referring FIGS. 1-4, the bracket (10) is an alternative to boarding windows or doors by applying nails, or other attachment means. Ideally, the bracket (10) should be used with the system (1) described below. However, because the bracket (10) can adjust to any thickness, it can be used plywood, aluminum, or other material that is deemed appropriate for boarding windows or doors.

The bracket (10) comprises a Mitzel Mount (11), a Foltz Frame (12), and a Denny Jamb (14). The Mitzel Mount (11) is a container having an extended lip (15). The well (16) of the Mitzel Mount (11) defines at least three holes (17, 18, 19). At least two holes (17, 18) are used to affix the Mitzel Mount (11) to a building. The center hole (19) is used to join the Foltz Frame (12).

The Foltz Frame (12) is an “L” shaped piece. The “L” consists of a vertical side (21) and a horizontal side (22). The vertical side (21) is longer that the horizontal (22) side. Referring to FIG. 1, the Denny Jamb (14) is shaped like a rectangular brick. The Denny Jamb (14) defines at least one Denny Jamb hole (23).

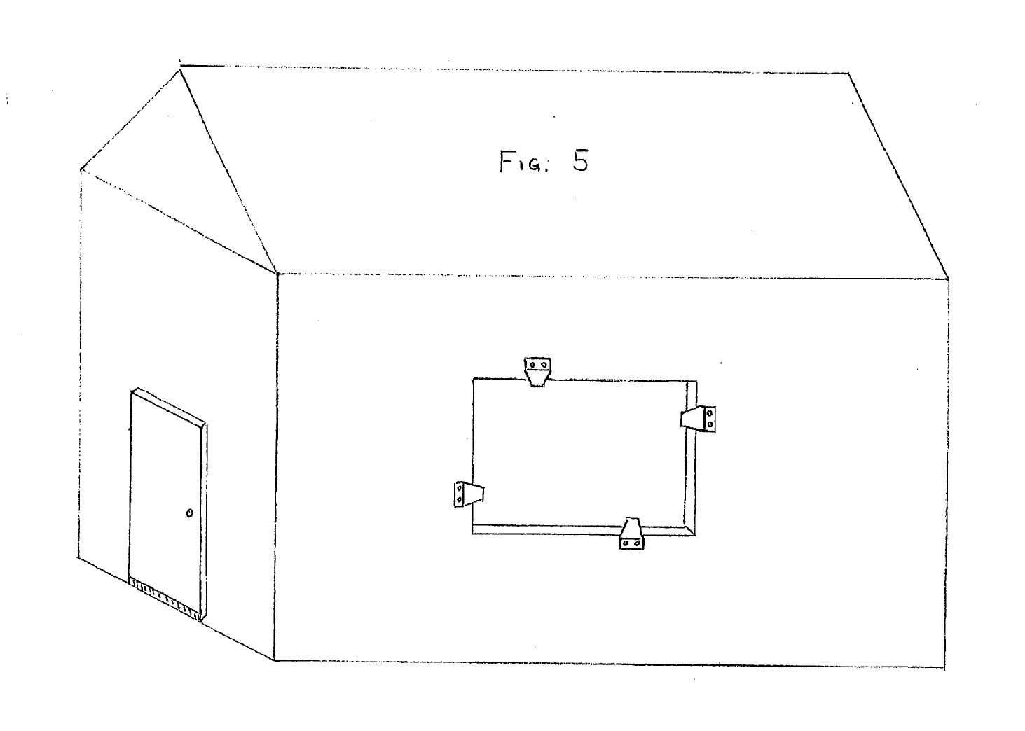

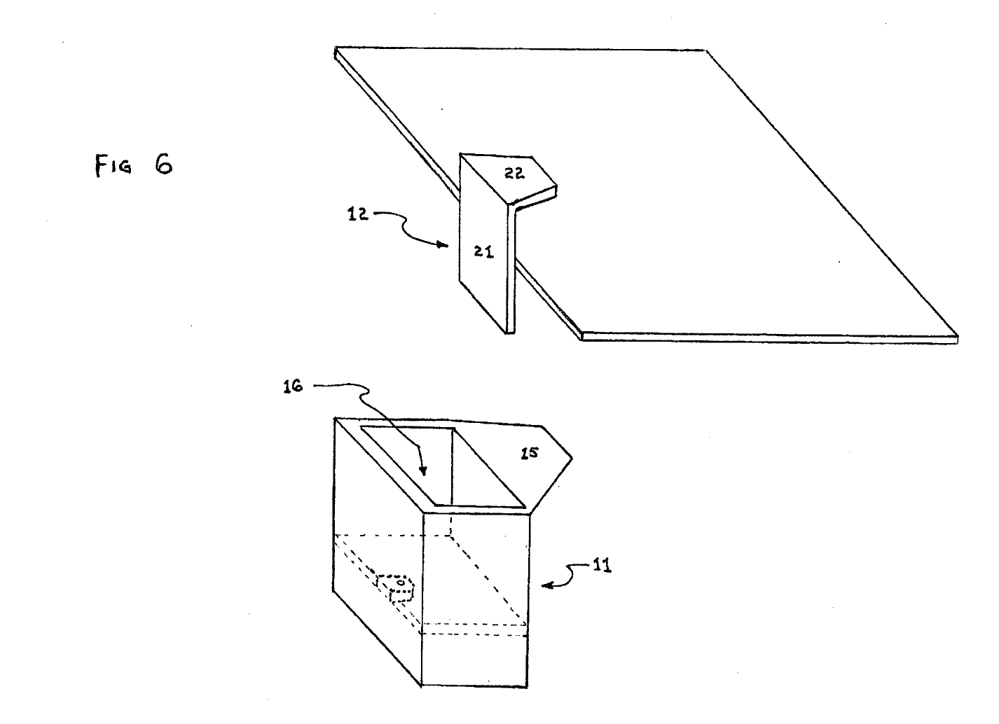

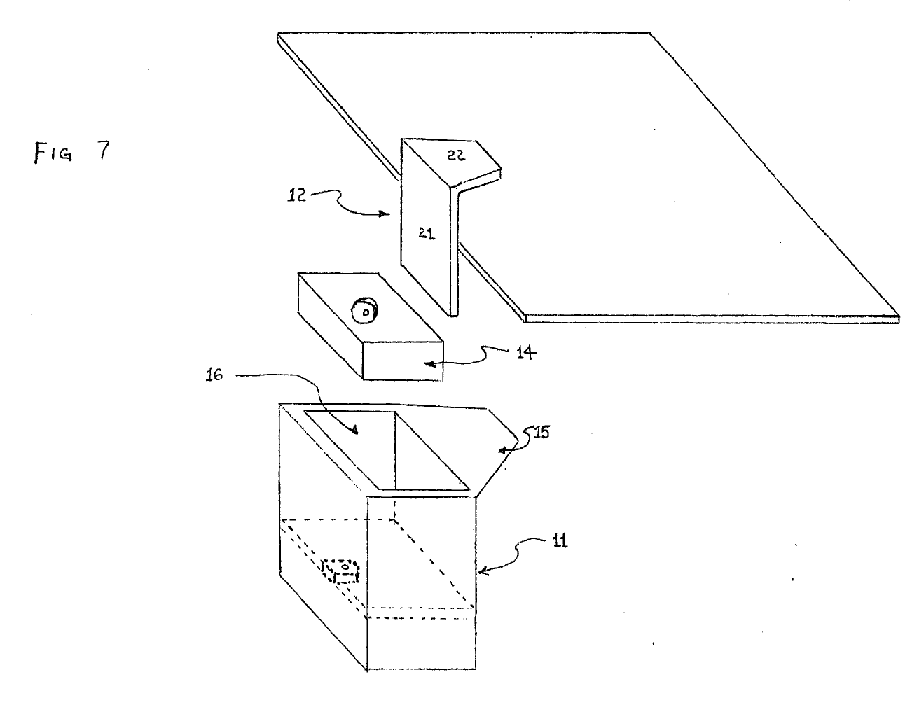

Referring to FIGS. 5-7, at least one bracket (10) is mounted on each side of a window or door. To mount the bracket (10) the Mitzel Mount (11) is secured to a structure so that its well (16) is facing away from the structure and the extended lip (15) is pointing to the center of the window or door. In the preferred embodiment, the Mitzel Mount (11) is secured to the structure using screws that go through the attachment holes (17, 18) and into the structure. However, it will be obvious to a person having ordinary skill in the art that any standard fastener can be used, depending on the requirements of the user and the material of the structure.

Next, the boarding material is lined up with the brackets (10) and the window or door. The boarding material should lay flush against the extended lip (15) of the Mitzel Mount (11). The vertical side (21) of the Foltz Frame (12) slides into the Mitzel Mount (11) so that the boarding material is sandwiched between the horizontal side (22) of the Foltz Frame (12) and the extended lip (15) of the Mitzel Mount (11).

Finally, the Denny Jamb (14) is pushed into the well (16) of the Mitzel Mount (11) to hold the boarding material and Foltz Frame (12) in place. The Denny Jamb (14) is secured to the Mitzel Mount (11) with a bolt that is washered through the Denny Jamb (14) Denny Jamb hole (23) and threaded into the centered Mitzel Mount hole (19). The centered Mitzel Mount hole (19) has a smaller diameter than the threaded Denny Jamb hole (23). In the preferred embodiment, the Denny Jamb hole is covered with a grommet (30).

To remove the boarding material, the grommet (30) is removed and the Denny Jamb (14) is unbolted from the Mitzel Mount (11). A bolt that has a diameter larger than the centered Mitzel Mount hole (19) is thread through until it reaches the bottom of the well (16) and the Denny Jamb (14) is pushed out of the Mitzel Mount (11).

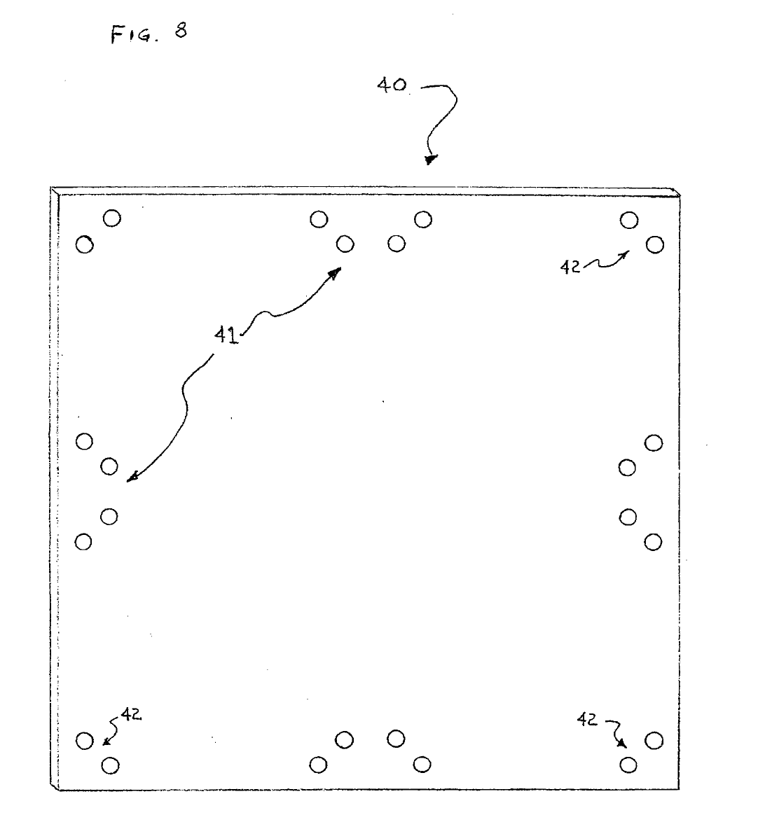

THE SHIELD SYSTEM. Referring to FIG. 8, in the preferred embodiment, the shield (40) is rectangular and made from polycarbonate plastic. Optimally, the shield (40) has dimensions 4 ft.×4 ft. or 2 ft.×4 ft. However, it will be obvious to a person having ordinary skill in the art that the shield (24) can also be made of plywood, aluminum, or other material suitable for boarding windows or doors.

In the preferred embodiment, the shield (40) defines holes on each edge. The center portion of each edge defines at least one center hole (41). Optimally, there are 4 center holes (41) arranged in a semi-circular pattern. Each corner of the shield (40) defines at least one corner hole (42). Optimally, there are 2 corner holes (42) on each corner of the shield (20). The center holes (21) and corner holes (22) are used to join multiple shields together when boarding a larger window or door.

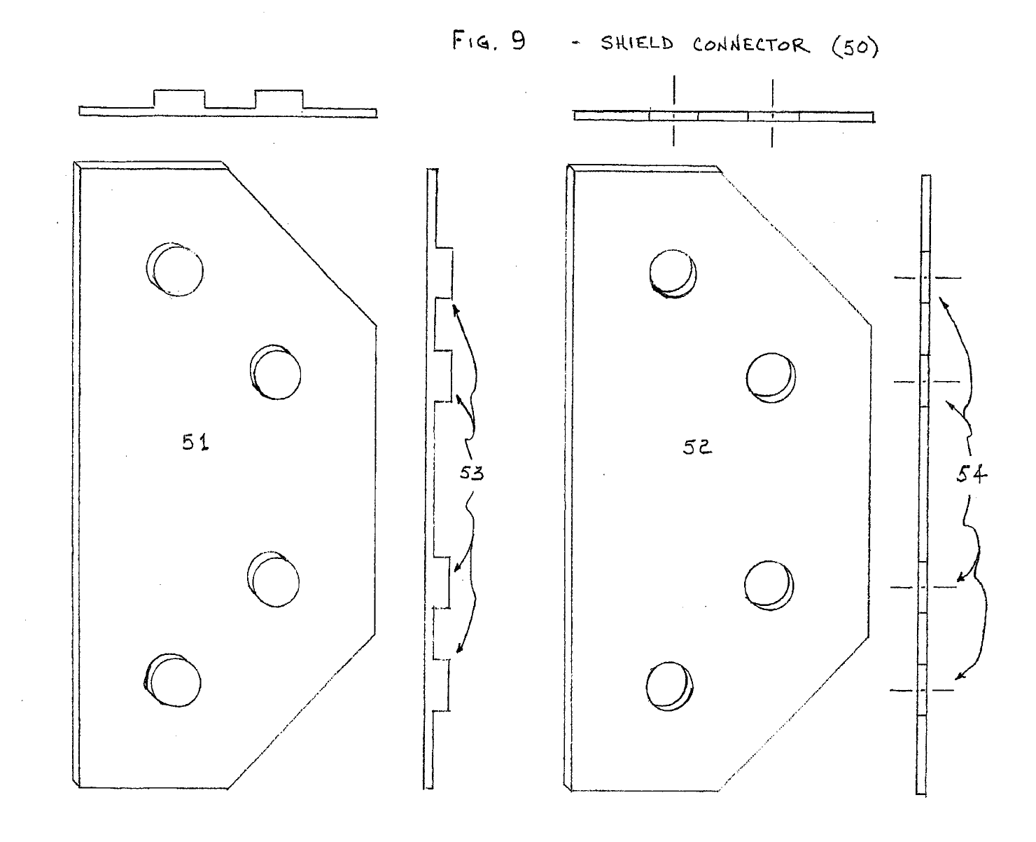

Referring to FIG. 9, the system (1) further comprises at least one shield connector (50). The shield connector (50) comprises a male connector (51) and a female connector (52). The male connector defines at least one tab (53); optimally, the male connector defines 4 tabs (53) which line up with the center holes (41) and corner holes (42) of the shield (40). The female connector defines at least one connector hole (54); optimally, the female connector (52) defines 4 connector holes (54). The tabs (53) are placed so that each mates with a connector hole (54).

If one shield is sufficient to cover a window or door, the process to board is identical to the one described above. However, if multiple shields (40) are necessary, the shields (40) are joined together using shield connectors (50).

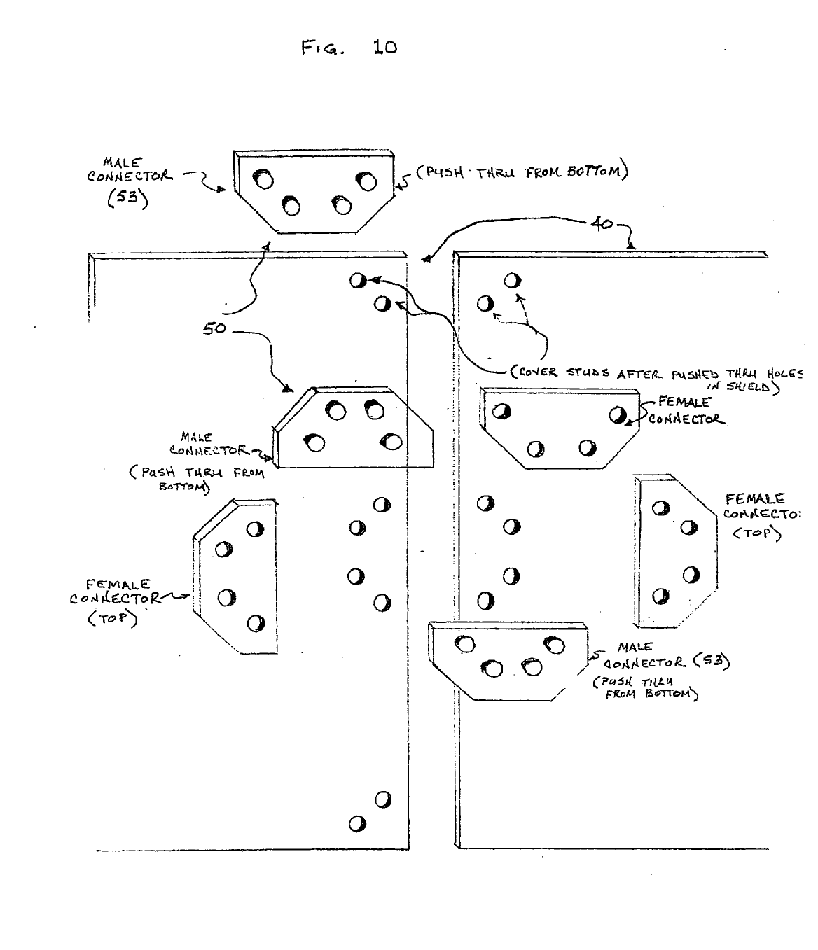

Referring to FIG. 10, male tabs (53) are aligned with the holes on (41, 42), as necessary, and threaded through. The tabs (53) are then aligned with the connector holes (54) and threaded through. In the preferred embodiment, plastic weld is applied to the protruding tabs (53) just prior to setting the female connector (52). It should be noted that a person having ordinary skill in the art would recognize that any appropriate type of adhesive can be used. This process can be repeated to create larger shields. The plurality of shields is used to board the window or door using the bracket (10) described above.

One bracket (10) should be used on each edge of the shield (40). If multiple shields (40) are secured together, one bracket should be used on each exposed edge of the extended shield (40). For example, two shields (40) connector together using the shield connector (50) would require six brackets for mounting. More generally, the user would require: 2×(number of shields)+2 end brackets.

The invention claimed is:

1. A bracket, used to board window or doors, comprising a mount, a frame and a jamb.

2. The bracket of claim 1 where the mount is a container; the open end of the container has an extended lip.

3. The bracket of claim 2 where the closed end of the mount has a means to secure the mount to a structure and defines at least one hole.

4. The bracket of claim 1 where the frame is “L” shaped having a vertical side and a horizontal side; said vertical side is longer than the horizontal side.

5. The bracket of claim 1 where the jamb is shaped as a brick and defines at least one hole.

6. A method to use the bracket of claim 1 comprising:
(a) securing one mount on each side of a window or door such that its well is facing away from the structure and the extended lip is pointing to the center of the window or door;
(b) lining up boarding material to at least one mount;
(c) sliding vertical side of frame into the well of the mount so that the boarding material is sandwiched between the horizontal side of the frame and the extended lip of the mount.
(d) pushing the jamb into the well of the frame holding the boarding material and frame in place.

7. An extendable shield to be used as boarding material comprising at least one portion of boarding material and at least one connector.

8. The extendable shield of claim 7 where the at least one boarding material comprises at least one hole on each side.

9. The extendable shield of claim 7 where the at least one connector comprises a female connector and a male connector.

10. The extendable shield of claim 9 where the male connector defines at least two connector tabs and the female connector defines at least two connector holes.

11. A method to join a portion of boarding material as defined in claim 10 to another portion of boarding material as defined in claim 10 comprising:
(a) aligning the at least two connector tabs with the holes defined by the boarding material;
(b) threading the connector tabs through the boarding material holes;
(c) applying the appropriate type of adhesive to the connector tabs;
(d) mating the female connector holes with the male connector tabs.
